(19) United States
(12) Patent Application Publication
(10) Pub. No.: US 2007/0236739 A1
(43) Pub. Date: Oct. 11, 2007

(54) Method and apparatus for image processing

(75) Inventors: Naoya Murakami, Yokohama-shi (JP); Takashi Shimazaki, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/392,942

(22) Filed: Mar. 30, 2006

(51) Int. Cl. G06K 15/00

(52) U.S. Cl. 358/3.06; 358/3.12

(57) ABSTRACT

The present invention relates to an image processing apparatus which can improve the output image quality by replacing characters and line drawings of intermediate density difficult to reproduce in view of the characteristics of a printer with a density, line width, or screen which can be reproduced stably.

### BACKGROUND OF THE INVENTION

1. Field of the Invention

The present invention relates to an image processing apparatus and an image processing method which permit the output image quality to be improved by reproducing characters and line drawings of intermediate density difficult to reproduce due to being affected by the characteristics of a printer with a density, line width, or screen which can be reproduced stably.

2. Description of the Related Art

Printer apparatuses which printout images have come into wide use in recent years. The printers can be classified into ink jet printers and electrophotographic printers in terms of the image forming process utilized, i.e., the printer engine.

The printer apparatuses have become cheaper and faster and are now available in various types from a printer type having a printing function only to a multifunction type multifunction peripheral (MFP).

Low-cost printers, typified by ink jet printers, generally treat color reproduction with color inks as important. Intermediate- and high-class MFP apparatuses or high-speed apparatuses generally use the electrophotography technology.

With the electrophotographic printers and the ink jet printers, in outputting digital data images created by a personal computer (PC) or the like it is not easy to printout (reproduce) images which accurately match image data because of problems caused by the printer characteristics. For example, light-colored characters and fine lines which can be confirmed on the monitor may cause problems of patchy or breaks when printed out.

This is attributed to variations in the environment in which the apparatus is installed, the effect of expendable supplies, such as toner, developer, etc., and instability of dot formation in the electrophotographic technology, etc.

Therefore, it would be difficult to accurately reproduce light-colored characters and fine lines even if the image formation capability of the printer engine could be improved.

That is, there is a problem that the reproducibility of fine lines and characters of intermediate density falls due to the printer characteristics when images are output through a MFP or printer.

Japanese Unexamined Patent Publication No. 5-176164 discloses an image processing method and an image processing apparatus which allow blocked-up in high-density areas to be suppressed.

### BRIEF SUMMARY OF THE INVENTION

An object of the present invention is to provide a correction method which can provide an image of characters/line drawings produced with an intermediate density with a line width and an image density corresponding to the characteristics of an output device and to increase the reproducibility of characters/line drawings.

The present invention provides an image processing apparatus comprising: a line width detecting section which detects the line width in each of the main scanning direction and the sub-scanning direction of an arbitrary pixel in input image data; an image density decision section which detects the density of the arbitrary pixel which has its line width detected by the line width detecting section; a line width decision/density conversion section which determines whether to carry out density conversion or not on the basis of the output of each of the line width detecting section and the image density decision section; and a halftone processing section which imparts a screen reproducible by a printer engine to image data to be printed out output from the line width decision/density conversion section.

Also, the present invention provides an image processing apparatus comprising: a line width detecting section which detects the line width in each of the main scanning direction and the sub-scanning direction of an arbitrary pixel in input image data; an image density decision section which detects the density of the arbitrary pixel which has its line width detected by the line width detecting section; a line width decision/density conversion section which determines whether to carry out density conversion or not on the basis of the output of each of the line width detecting section and the image density decision section; and a halftone processing section which imparts gradations reproducible by a printer engine to image data to be printed out output from the line width decision/density conversion section on the basis of the error diffusion method.

Additionally, the present invention provides an image forming apparatus comprising: a line width detecting section which detects the line width in each of the main scanning direction and the sub-scanning direction of an arbitrary pixel in input image data; an image density decision section which detects the density of the arbitrary pixel which has its line width detected by the line width detecting section; a line width decision/density conversion section which determines whether to carry out density conversion or not on the basis of the output of each of the line width detecting section and the image density decision section; a printer engine which is supplied with image data to be printed out to output an image onto an output medium; a TAG information producing section which obtains which of text, graphic and image the attribute of the input image belongs to from a drawing command involved in the input image data; and a halftone processing section which imparts gradations reproducible by the printer engine to image data to be printed out output from the line width decision/density conversion section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a schematic block diagram of an image processing apparatus/printer apparatus (image forming apparatus) to which the invention is adapted;

FIG. 2 is a schematic diagram of a line width/density conversion processing section (image processing section) used in the image processing apparatus/printer apparatus shown in FIG. 2;

FIG. 3 is a schematic diagram of the line width/density conversion processing section shown in FIG. 2;

FIG. 4A is a schematic diagram of the line width decision section in the line width/density conversion processing section shown in FIG. 3;

FIG. 4B is a schematic diagram of the horizontal (main scanning direction) line width decision section of the line width decision section shown in FIG. 4A;

FIG. 4C is a schematic diagram of the vertical (sub-scanning direction) line width decision section of the line width decision section shown in FIG. 4A;

FIGS. 5A and 5B are schematic diagrams of a truth table and a correction value table for the line width and the density identified by the decision section shown in FIGS. 2, 3, 4A, 4B and 4C;

FIG. 6 is a schematic diagram for use in explanation of switching of combinations of density correction and halftone processing (screen/error diffusion); and

FIG. 7 is a schematic diagram of a setting (input) display which allows the user to decide whether to make correction on the line width and density identified by the decision section shown in FIGS. 2, 3, 4A, 4B, and 4C.

### DETAILED DESCRIPTION OF THE INVENTION

An embodiment of the present invention will be described hereinafter with reference to the accompanying drawings. This invention can improve the quality of an image to be output by reproducing the line width, density, screen, and so on of the image, which are difficult to reproduce, to fit the characteristics (image formation latitude) of a printer engine taking into consideration its characteristics in advance.

The main part of an image processing apparatus/printer apparatus (image formation apparatus) to which the embodiment of the present invention is adaptable is shown.

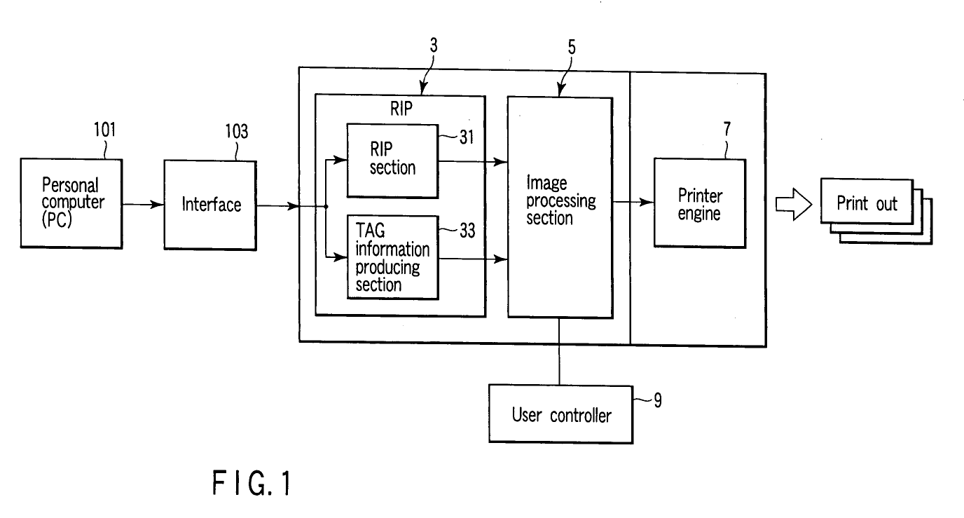

The printer apparatus (image formation apparatus) shown in FIG. 1 includes an interface (PDL video interface or the like) 103 which receives image data (a multilevel image) supplied from an external device which is an image data provider, for example, a personal computer (PC) 101, a raster image processor (RIP) section 3 which rasterizes the multi-level image (image data) input through the interface 103, an image processing section 5 which, from the raster image data from the RIP section 3, detects the line width in the main and sub-scanning directions of each individual image data (pixel of interest) contained in the raster data and the image density of the pixel of interest, and a printer engine 7 which outputs printout on the basis of the image data output from the image processing section 5.

For example, the image processing section 5 (or the printer engine 7) may be provided with a user controller 9 which allows the user to input a command to cancel image processing (a command as to whether to apply the inventive image processing or not) or to change controlled variables given to the raster data by the present invention. In this case, for the user controller 9 use is made of a display device (for example, an LCD panel) which allows the results of execution of the inventive image processing (changes in image data resulting from execution of the inventive image processing) to be displayed in terms of, say, image information or numeric values or a touch panel which allows both the display and the entry of numeric values.

The RIP section 3 includes an RIP 31 which converts the multilevel image data input through the interface 103 into raster data (data resulting from development of input image data in time sequence in the main scanning direction (in many cases the direction perpendicular to the direction in which an output medium [paper] onto which printout is output) is carried) and in the sub-scanning direction perpendicular to the main scanning direction) and a TAG information producing section 33 which decides the attribute of the input multilevel image data and attaches TAG information corresponding to the attribute to it. The TAG information producing section 33 divides the attribute of input image data to the RIP section 3 into, for example, TEXT (characters), Graphic (line drawing), Image (photo/gradation) using image related settings and drawing commands contained in PDL video interface and, for each attribute, attaches 0 for TEXT (characters), 1 for Graphic (line drawing) or 2 for Image (photo/gradation).

The method of processing image data (conversion into raster data) in the RIP 31 is well known and hence the detailed description thereof is omitted. The features of the present invention will be described hereinafter assuming that input image data is multi-valued and, in the interface 103, is decomposed into color components of C, M, Y, and K (black) which conform to the subtractive process.

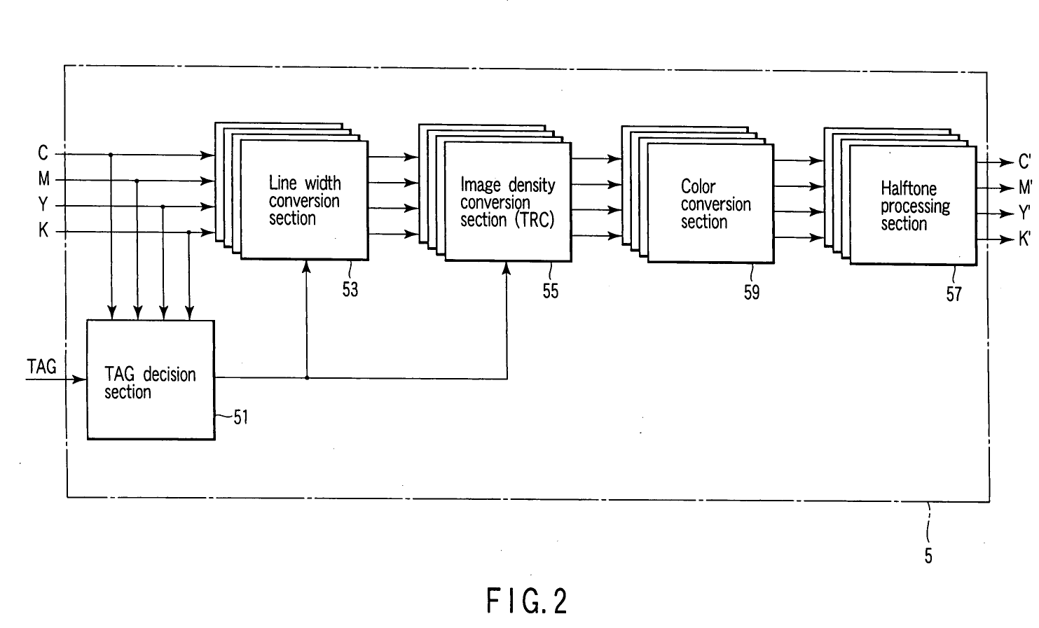

The image processing section 5, as shown exemplarily in FIG. 2, includes a TAG information decision section 51 which identifies the attribute of currently input image data in accordance with TAG information output from the TAG information producing section 33 (of the RIP section 3), a line width conversion section 53 which identifies the line width for each individual pixel from raster data (C, M, Y, K) rasterized in the RIP 31 (of the RIP section 3) and converts the line width (of the pixel (pixel of interest) as necessary, a density conversion section 55 which converts the image density of output image data from the line width conversion section 53 as necessary, and a halftone processing section 57 which sets the screen (the line density per section length at image output time) at output time according to TAG information decided by the TAG information decision section 51. In the halftone processing section 57, any halftone processing method typified by, say, the error diffusion method can be used in addition to the aforementioned screen setting method. It is also possible to provide a color conversion section 59 between the halftone processing section 57 and the density conversion section 55. For color conversion, various techniques (conversion methods) have been already put into practice and any color conversion method can be used in the present invention. Therefore, a detailed description of the color conversion section is omitted.

The printer engine 7, which is an arbitrary (known) image output apparatus of, say, the electrophotographic or ink jet type, outputs an image onto an output medium prepared as requested by the user, such as a sheet of paper, a sheet of transparent film, etc., through the use of C, M, Y, and K of toner or ink.

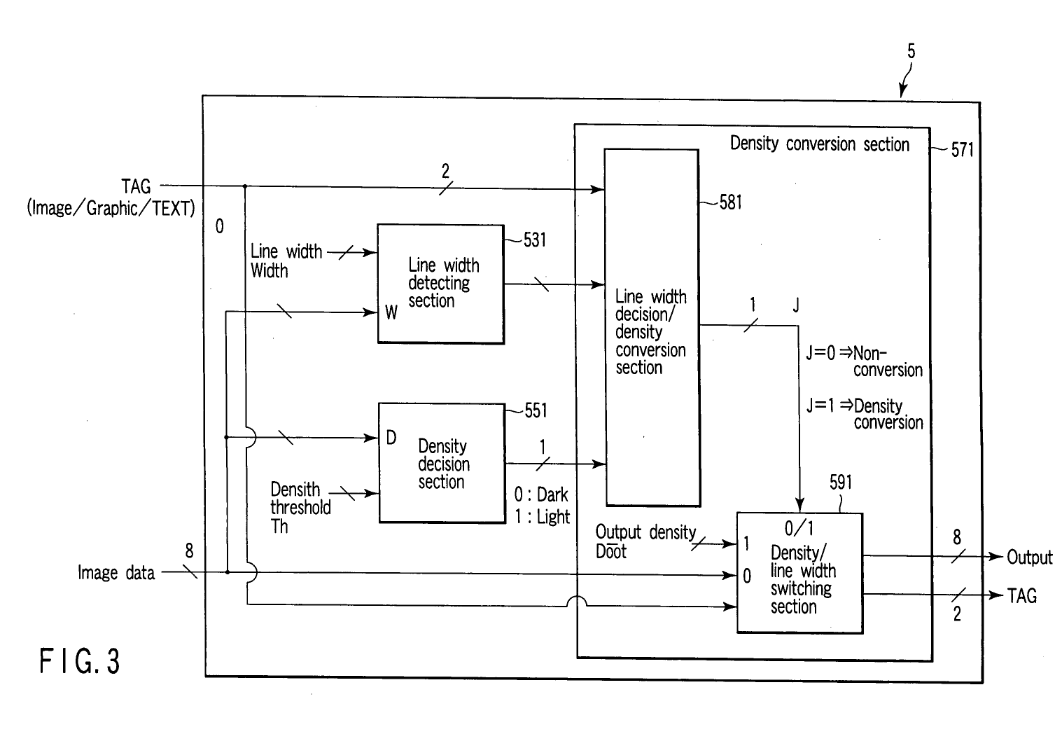

FIG. 3 is a more detailed block diagram of the line width conversion section and the density conversion section in the image processing section outlined in conjunction with FIG. 2. The line width conversion section and the density conversion section are each illustrated as an independent block in FIG. 2; however, in practice, they may be combined into an image processing section as shown in FIG. 3.

The image processing section 5, that is, the line width conversion section 53 and the density conversion section 55 shown in FIG. 2, is defined by an line width detecting section 531, a density decision section 551, and a decision conversion section 571, for example. The decision conversion section 571 further includes a line width decision/density conversion section 581 and a density/line width switching section 591.

In the line width detecting section 531, the line width of each individual image data is detected (decided) on the basis of an image signal and a TAG signal input from the preceding-stage processing section (the RIP section 3 in FIG. 1). The results of decision (detection) by the line width detecting section 531, that is, line width data, are input to the line width decision/density conversion section 581. In the line width decision/density conversion section 581, for image data under specific conditions, U (or) with the output of the density decision section 551 illustrated below is determined.

The density decision section 551 compares an input image signal with a predetermined threshold TH and determines whether the image density is to be corrected or not as follows:

if image data >TH, then 0

if image data ≦TH, then 1

Using the result of line width decision (detection) by the line width detecting section 531, the result of density decision by the density decision section 551, and the TAG information (0: TEXT (characters)/1: Graphic/2: Image (photo/gradation)) previously produced in the RIP section 3 (of FIG. 1), the density/line width switching section 591 performs density conversion on pixels of interest in accordance with a selected one of the following processes 1) to 3):

1) As for a character area, if the density of an input image is lower than a predetermined set density and its line width is a predetermined width (width 1) or less, then it is output with the output image density converted to a predetermined image density (Dout). Therefore, for an image such that line width >width 1, it is output as it is with no density conversion to Dout.

The image signal is output with high-density screen in the halftone processing section 57 because the TAG information indicates the character attribute.

Thus, as for image data which is in a character area and has a line width of a predetermined width or less, even light-colored characters can be reproduced surely without being affected by engine variations by converting the image density to a predetermined density (darker than the original image). That is, characters such that the line width is small and the image density is small are replaced with image data of a given density or more.

2) As for a line drawing area as well, like 1) a character area, fine lines of a given line width and density or less has its image density converted to the predetermined image density (Dout).

If the line width is the given width or less, correction to increase the line width may be used at the same time.

As for a solid area contained in the line drawing area, the output image signal (line drawing) can be output with low line-numbers screen with preference given to gradation characteristics on the basis of TAG information.

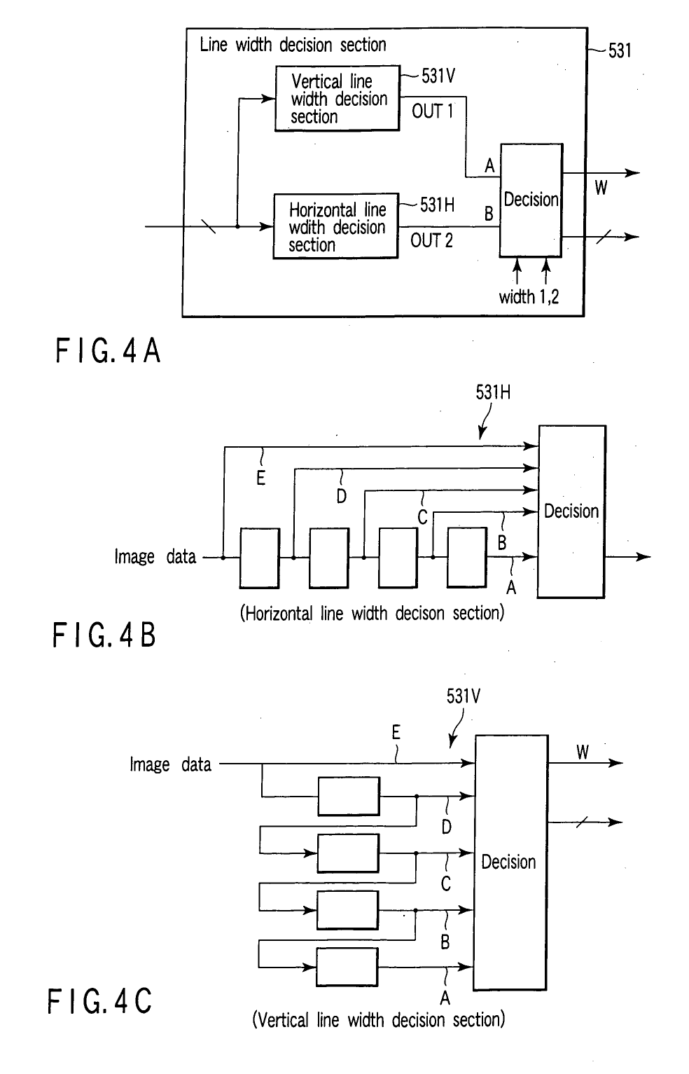

FIGS. 4A to 4C illustrate the operation of the line width decision section 531 shown in FIG. 3 in more detail.

The line width detecting section 531 includes a horizontal (main scanning direction) line width decision section 531H and a vertical (sub-scanning direction) line width decision section 531V as shown in FIG. 4A.

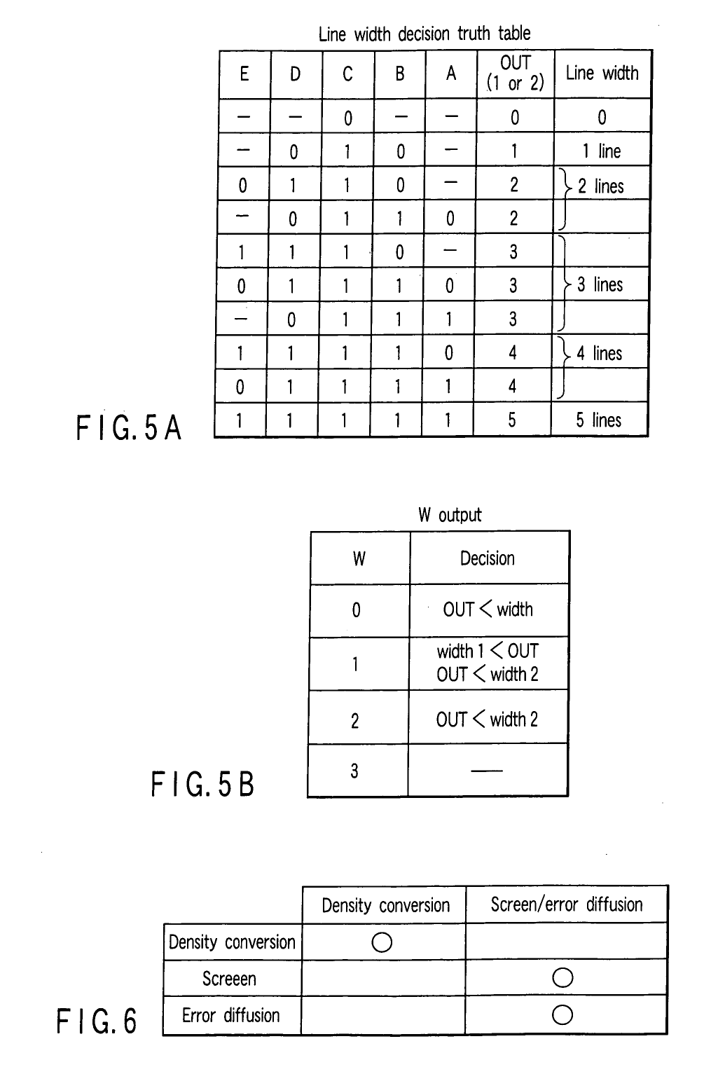

As shown in FIG. 4B, the horizontal line width decision section 531H detects the density distribution of pixels of interest using the inputs and outputs A to E of four series-connected (first to fourth) registers by way of example. According to a truth table shown in FIG. 5A, the horizontal line width decision section then decides the line width to be 0 if, for example, C is 0, to be one line if, for example, C is 1 and B and D are each 0, and to be five lines if, for example, A to E are each 1. When the OUT value defined in the truth table shown in FIG. 5A is less than 1, that is, the OUT value is 0, in the density/line width switching section 591 the output image density is converted to the predetermined image density Dout in accordance with correction decision shown in FIG. 5B.

As shown in FIG. 4C, the vertical line width decision section 531V detects the density distribution of pixels of interest using the inputs and outputs A to E of four (first to fourth) line memories connected in sequence (like delay circuits) by way of example. According to the truth table shown in FIG. 5A, the vertical line width decision section then decides the line width to be 0 if, for example, C is 0, to be one line if, for example, C is 1 and B and D are each 0, and to be five lines if, for example, A to E are each 1. In this case, as with the horizontal line width, when the OUT value defined in the truth table shown in FIG. 5A is less than 1, that is, the OUT value is 0, in the density/line width switching section 591 the output image density is converted to the predetermined image density Dout in accordance with correction decision shown in FIG. 5B.

That is, in the inventive image processing section, the horizontal line width decision section 531H and the vertical line width decision section 531V detect (decide) the line width of image data independently for each of the main scanning direction and the sub-scanning direction for each individual pixel of interest. The decision conversion section 571 (i.e., the line width decision/density conversion section 581) decides whether to perform density correction on the line width or not and whether the line width in an arbitrary direction of image data is in the specified decision range or not. If density correction is necessary, the density/line width switching section 591 corrects (converts) the image density at the time of output to the printer engine 7 on the basis of the line width and the image attribute (TAG information).

By performing the above processing on each individual pixel in input image data, a printer can be provided which is improved in the reproducibility of halftone characters and fine lines.

As the halftone processing (the actual form of the halftone processing section 57) in the image processing section, either of the change of the screen density and the halftone processing based on the error diffusion method can be selected as described above. For example, as shown in FIG. 6, the density conversion illustrated in 1) to 3) may be combined with I) the switching of screen density or II) the error diffusion method.

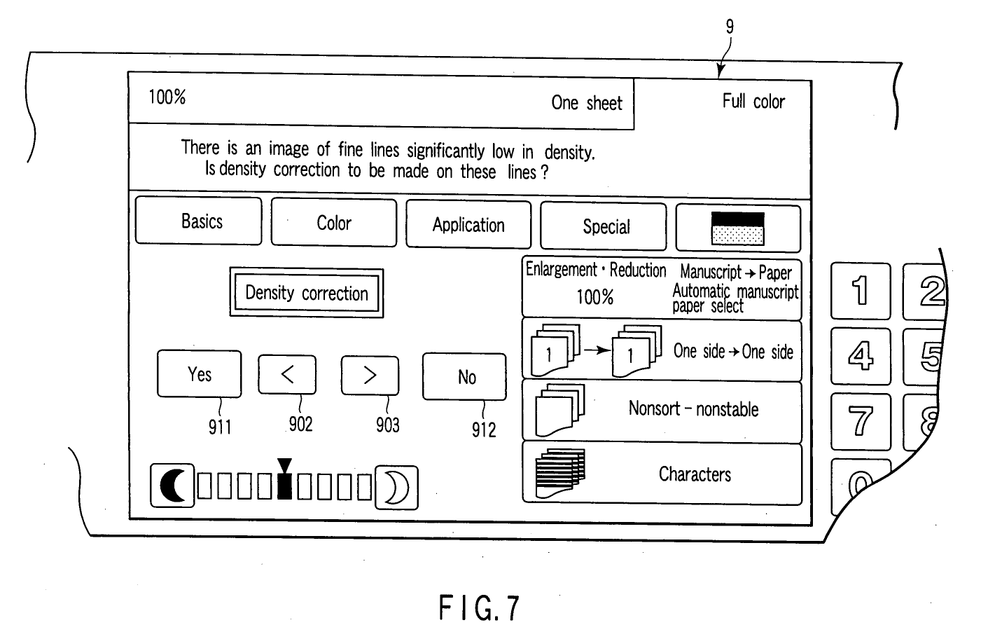

Whether the density conversion illustrated in 1) to 3) is to be executed or not can be arbitrarily set as the user likes. For example, as shown in FIG. 7, on the display section 901 in the user controller 9 is displayed a message such that

There is an image of fine lines significantly low in density. Is density correction to be made on these lines?

For example, by selecting a YES indication 911 or a NO indication 912 on the display section 901 through a “<” key 902 or “>” key 903, the cancellation (non-execution) or the execution of the processing can be selected.

As described above, according to the image processing apparatus of the present invention, characters and line drawings of intermediate density which are difficult to reproduce in view of printer characteristics can be replaced with the density, line width or screen which can be reproduced stably to improve the output image quality.

That is, an multilevel image made on a PC or the like (supplied from an external device) is entered into the image processing section through the printer driver (interface). In the image processing section, the line width/density conversion processing and the halftone processing are carried out on the image, which is then output as printout from the printer engine.

In this case, in the image processing section, image information (data) is separated into character, line drawing and photograph areas using a TAG signal produced at RIP time for line width/density/halftone conversion processing.

a) As for the character area, when an image which is lighter than the setting density is input (input image data is decided to have an image density of a predetermined value or less), it is converted to the predetermined image density and output with high-density screen. In the case where the image has a line width of a given value or more, however, it is output with its input density unchanged and with high-density screen.

b) As for the line drawing area, fine line portions of a predetermined line width or less are converted to a predetermined density like characters and output with high-density screen (depending on the area separation capability of the RIP). When line drawings have line widths of a predetermined value or less, they are converted to have the predetermined line width and then output. However, with a solid area contained in a line drawing area, the image is output with its density unchanged and with low line-numbers screen.

c) As for the photograph area, the input image is output with its density unchanged and with low-density screen like the solid area of line drawings.

Thereby, the reproducibility and stabilization of halftones can be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a line width detecting section which detects the line width in each of the main scanning direction and the sub-scanning direction of an arbitrary pixel in input image data;
an image density decision section which detects the density of the arbitrary pixel which has its line width detected by the line width detecting section;
a line width decision/density conversion section which determines whether to carry out density conversion or not on the basis of the output of each of the line width detecting section and the image density decision section; and
a halftone processing section which imparts a screen reproducible by a printer engine to image data to be printed out output from the line width decision/density conversion section.

2. The image processing apparatus according to claim 1, wherein the line width detecting section includes a first line width detecting section which detects the width in the main scanning direction of the arbitrary pixel and a second line width detecting section which detects the width in the sub-scanning direction of the arbitrary pixel.

3. The image processing apparatus according to claim 1, further comprising a TAG information producing section which obtains which of text, graphic and image the attribute of the input image belongs to from a drawing command involved in the input image data.

4. The image processing apparatus according to claim 3, wherein the line width decision/density conversion section determines whether to perform density conversion or not on the basis of the attribute of the image obtained by the TAG information producing section and the outputs of the line width detecting section and the image density decision section.

5. The image processing apparatus according to claim 3, wherein the line width decision/density conversion section outputs a correction output to increase the image density when the input image data is text or graphic and the line width of each individual pixel is smaller than a predetermined width.

6. The image processing apparatus according to claim 5, further comprising a density correction determining section which inputs whether or not the line width decision/density conversion section is to output the correction output to increase the image density.

7. An image processing apparatus comprising:
a line width detecting section which detects the line width in each of the main scanning direction and the sub-scanning direction of an arbitrary pixel in input image data;
an image density decision section which detects the density of the arbitrary pixel which has its line width detected by the line width detecting section;
a line width decision/density conversion section which determines whether to carry out density conversion or not on the basis of the output of each of the line width detecting section and the image density decision section; and
a halftone processing section which imparts gradations reproducible by a printer engine to image data to be printed out output from the line width decision/density conversion section on the basis of the error diffusion method.

8. The image processing apparatus according to claim 7, wherein the line width detecting section includes a first line width detecting section which detects the width in the main scanning direction of the arbitrary pixel and a second line width detecting section which detects the width in the sub-scanning direction of the arbitrary pixel.

9. The image processing apparatus according to claim 7, further comprising a TAG information producing section which obtains which of text, graphic and image the attribute of the input image belongs to from a drawing command involved in the input image data.

10. The image processing apparatus according to claim 9, wherein the line width decision/density conversion section determines whether to perform density conversion or not on the basis of the attribute of the image obtained by the TAG information producing section and the outputs of the line width detecting section and the image density decision section.

11. The image processing apparatus according to claim 9, wherein the line width decision/density conversion section outputs a correction output to increase the image density when the input image data is text or graphic and the line width of each individual pixel is smaller than a predetermined width.

12. The image processing apparatus according to claim 11, further comprising a density correction determining section which inputs whether or not the line width decision/density conversion section is to output the correction output to increase the image density.

13. An image forming apparatus comprising:
a line width detecting section which detects the line width in each of the main scanning direction and the sub-scanning direction of an arbitrary pixel in input image data;
an image density decision section which detects the density of the arbitrary pixel which has its line width detected by the line width detecting section;
a line width decision/density conversion section which determines whether to carry out density conversion or not on the basis of the output of each of the line width detecting section and the image density decision section;
a printer engine which is supplied with image data to be printed out to output an image onto an output medium;
a TAG information producing section which obtains which of text, graphic and image the attribute of the input image belongs to from a drawing command involved in the input image data; and
a halftone processing section which imparts gradations reproducible by the printer engine to image data to be printed out output from the line width decision/density conversion section.

14. The image forming apparatus according to claim 13, wherein the line width decision/density conversion section determines whether to perform density conversion or not on the basis of the attribute of the image obtained by the TAG information producing section and the outputs of the line width detecting section and the image density decision section.

15. An image processing method comprising:
detecting the line width in each of the main scanning direction and the sub-scanning direction of an arbitrary pixel in input image data;
detecting the density of the arbitrary pixel which has its line width detected by the line width detecting section;
obtaining which of text, graphic and image the attribute of the input image belongs to from a drawing command involved in the input image data;
determining whether to carry out density conversion or not on the basis of the detected line width and image density and the obtained attribute of the image; and
imparting predetermined gradations to image data to be printed out.
